(19) United States
(12) Patent Application Publication
(10) Pub. No.: US 2004/0185421 A1
(43) Pub. Date: Sep. 23, 2004

(54) Method of using a tissue contourer

(75) Inventors: Carl W. Schulter, Memphis, TN (US); Andrew J. Schulter, Memphis, TN (US)

Correspondence Address: STEPHEN M. PATTON, 7881 GROVE COURT EAST, GERMANTOWN, TN, 38138, US

(73) Assignee: Cagenix, Inc.

(21) Appl. No.: 10/802,200

(22) Filed: Mar. 17, 2004

Related U.S. Application Data
(60) Provisional application No. 60/455,629, filed on Mar. 18, 2003.

(51) Int. Cl. A61C 8/00

(52) U.S. Cl. 433/173

(57) ABSTRACT

A method for using a tissue contourer includes making an incision in the oral cavity, inserting a tissue contourer in the incision; expanding the tissue contourer; removing the tissue contourer; and replacing the tissue contourer with an oral implant.

### RELATED APPLICATIONS

This application claims priority from U.S. Provisional Patent Application No. 60/455,629, which was filed on Mar. 18, 2003, and is entitled “Tissue Expander and Method of Using”. This application is related to the co-pending application entitled “Oral Tissue Contourer” filed contemporaneously herewith, which is incorporated herein by reference for all that it teaches.

### FIELD OF THE INVENTION

This invention relates generally to oral surgery. More particularly it relates to implantable oral devices and methods of using submucosal tissue expanders and contourers.

### BACKGROUND OF THE INVENTION

The implantation of dental endosseous implants prosthetics or grafting material underneath mucosal or periosteal tissue is a common procedure performed both on the maxilla and the mandible. For these procedures to be surgically successful, the implanted or inserted material needs to be covered with vascularized mucosal tissue to aid in bone growth and to prevent infection. This covering of tissue is called primary closure.

When implant and bone grafts are not completely covered, the bone can lose volume or become infected especially in recent surgical sites. Collagen and other barriers have been used relatively recently to help in achieving primary closure, but there is still a loss of bone in these applications due to the lack of blood flow to the surgical sites.

Another problem associated with submucosal implantation is the extreme pressure exerted on the devices or materials that are implanted. Some researchers have attempted to rebuild or recontour eroded maxillary and mandibular ridges. The mucosal tissue is opened, the bone graft material inserted submucosally, and the mucosa is then sutured over the top. Unfortunately, the suturing stretches the tissue causing it, in turn to apply pressure on the bone graft material. The added pressure on the bone graft material can cause it to migrate away from the site of the implantation. The bone graft is never integrated completely. The primary reason for this failure is the lack of sufficient tension-free tissue to cover the graft material.

In some cases the bone graft material will merely migrate away from the graft site. In other cases, particularly where a rigid implant is inserted under the skin, the mucosal tissue may be impossible to suture. In other cases, the sutures may tear. In other cases, the mucosal tissue may erode and the implant may break though. All of these failures are due to the lack of sufficient tissue for the primary closure itself to cover the implant.

What is needed therefore is an improved process of preparing mucosal tissue for oral implants that provides sufficient mucosal tissue for the primary closure. What is also needed is an improved process of implanting that provides sufficient mucosal tissue to accommodate the implanted device or material. What is also needed is a process that will stimulate the patient's own body to generate and contour the tissue. What is also needed is a process for opening the generated tissue and inserting the implantables. What is also needed is a process for suturing the generated tissue after the implantables are inserted with sufficient space to prevent their migration. What is also needed is a method of expanding and contouring the vascularized mucosal tissue, so that when the underlying bone is rebuilt or otherwise restructured, it will completely cover the bone and a state of tension-free primary closure will be achieved.

It is an object of this invention to provide all of these in one or more claimed embodiments.

### SUMMARY OF THE INVENTION

In view of the above, and in accordance with a first aspect of the invention, there is provided a method for implanting oral devices including the steps of making an incision in the oral cavity, inserting a tissue contourer in the incision; expanding the tissue contourer; removing the tissue contourer; and replacing the tissue contourer with an oral implant.

The method may include the step of making a second incision in the oral cavity prior to the step of removing the tissue contourer. It may also include the step of making the second incision in mucosal tissue overlying the tissue contourer. It may include the step of waiting for the incision to heal before expanding the tissue contourer. The step of replacing the tissue contourer with an endosseous implant may include the steps of replacing the tissue contourer with a dental endosseous implant, prosthetic, or grafting material.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore to the claims herein for interpreting the scope of the invention.

### BRIEF DESCRIPTION OF THE DRAWINGS

FIG. 1 is a facial view of an edentulous ridge that lies between two sets of teeth.

FIG. 2 is a top view of the ridge of FIG. 1.

FIG. 3 is a facial view of the edentulous ridge in which tissue flaps have been pulled to either side of the crest of the bone.

FIG. 4 is a top view of the ridge depicted in FIGS. 1-3.

FIG. 5 illustrates a tissue contourer that has been inserted under the mucosal tissue with the tissue sutured over the contourer for primary closure.

FIG. 6 shows the first of a series of injections of sterile solution to inflate the tissue contourer after the sutured tissue has healed and the sutures have been removed.

FIG. 7 is a cross-sectional view of a first preferred placement of the tissue contourer as seen in section 6-6 of FIG. 6. The contourer is illustrated in a location on the facial side of the edentulous ridge.

FIG. 8 is a cross-sectional view of a second preferred placement of the tissue contourer adjacent to the edentulous ridge as seen in section 6-6 of FIG. 6. The contourer is illustrated in a location on the lingual side of the edentulous ridge.

FIG. 9 is a cross-sectional view of a third preferred placement of the contourer adjacent to the edentulous ridge as seen in section 6-6 of FIG. 6. The contourer is illustrated in a location on the crest of the edentulous ridge

FIG. 10 is a cross-sectional view of a fourth preferred placement of the contourer disposed in a pronounced recess in the edentulous ridge as seen in section 6-6 of FIG. 6. This illustrates a preferred placement when the ridge shows characteristics of uneven bone resorption.

FIG. 11 illustrates the tissue contourer as it is expanded by a subsequent injection to its final dimensions.

FIG. 12 illustrates the tissue contourer after it has inflated to its ultimate and preferred terminal volume prior to a second incision along the crest to remove it.

FIG. 13 shows a tissue contourer removal process in which the second incision has been made and the flaps formed thereby being reflected to either side of the crest of the edentulous ridge.

FIGS. 14-16 illustrate an alternative process of oral tissue expansion. The illustrated process is an alternative to the steps shown in FIGS. 1-5, above.

FIG. 15 is a side view of the ridge of FIG. 14 showing the ridge after a tissue contourer insertion probe has been partially inserted into the incision illustrated in FIG. 14.

FIG. 16 is a side view of the ridge of FIGS. 14-15 showing the placement of a tissue contourer into the void formed by the probe of FIG. 15.

FIG. 17 is a side view of a first preferred tissue contourer insertion probe in the form of a tube, the central portion of the tube being configured to carry a tissue contourer and a video device.

FIG. 18 is a side view of a second preferred tissue contourer insertion probe having two elongate members and a tissue contourer disposed therebetween.

FIG. 19 is a side view of a third preferred tissue contourer insertion probe coupled to one side of a tissue contourer and engaging the nose of the tissue contourer.

FIG. 20 is a side view of an orthoscopic camera that can be inserted into the void and used to inspect the bone of the edentulous ridge prior to the step of placing the tissue contourer into the void created by the probe.

FIG. 21 illustrates a first placement of a preferred tissue contourer in a completely edentulous ridge.

FIG. 22 shows a second placement of two tissue contourers in a completely edentulous ridge.

FIG. 23 is a detailed view of the two tissue contourers of FIG. 22 showing a preferred fluid coupling between the two.

FIG. 24 is a detailed cross-sectional view of the coupling of FIG. 23 showing the fluid fill tubes of the two tissue contourers coupled together by a T-coupling.

FIG. 25 shows an arrangement of three tissue contourers in a completely edentulous ridge using a T-coupling between two adjacent contourers and a single fill tube for the third contourer.

FIG. 26 shows a second arrangement of three tissue contourers in a completely edentulous ridge, each contourer having its separate and distinct fill tube.

FIG. 27 illustrates a step of removing periosteal tissue from the surface of bone on the edentulous ridge underneath tissue contoured by a previously removed tissue contourer.

FIGS. 28-31 illustrate a process of attaching a block bone graft to the edentulous ridge after the tissue expander has been removed.

FIGS. 32-35 illustrate a process of anchoring implants in the tissue after the tissue contourer has been removed.

FIGS. 36-37 illustrate a process of fixing a structure such as a framework, mesh, or scaffolding to the edentulous ridge after the tissue contourer has been removed and filling the structure with bulk bone graft material after the tissue expander has been removed.

FIGS. 38-43 illustrate a process of punching openings in tissue overlying a previously removed tissue contourer and inserting implants through those openings into the underlying edentulous ridge.

### DETAILED DESCRIPTION OF THE PREFERRED EMBODIMENTS

While the present invention is susceptible to being embodied in various forms, the drawings show several preferred closure embodiments that will now be described. Please understand that the embodiments in this patent should be considered as just a handful of possible ways the invention might be embodied. They are provided here in sufficient detail for those skilled in the art of oral surgery to construct and perform. It is not intended to limit the invention to the specific embodiments described and illustrated here.

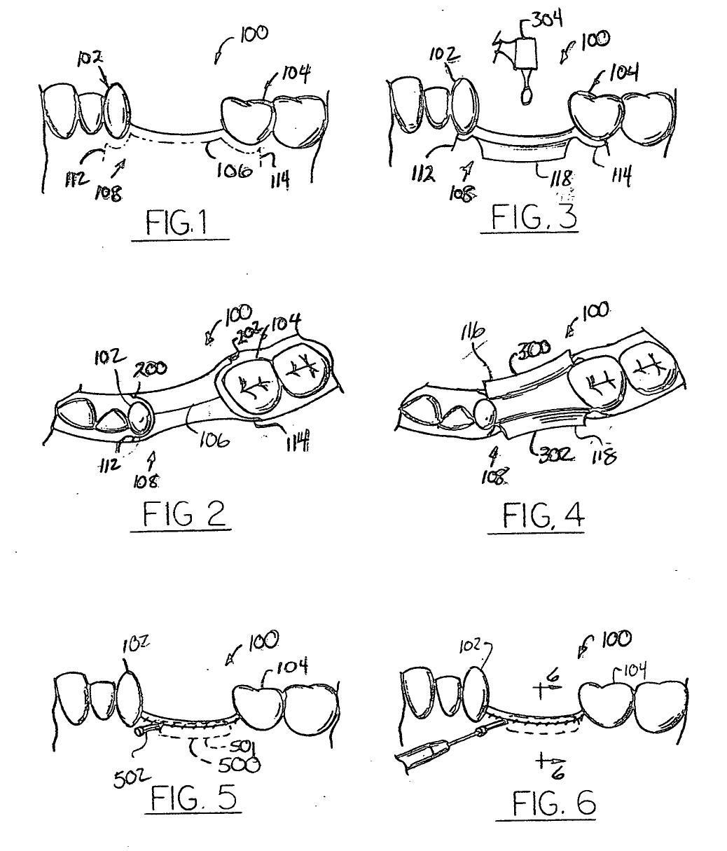

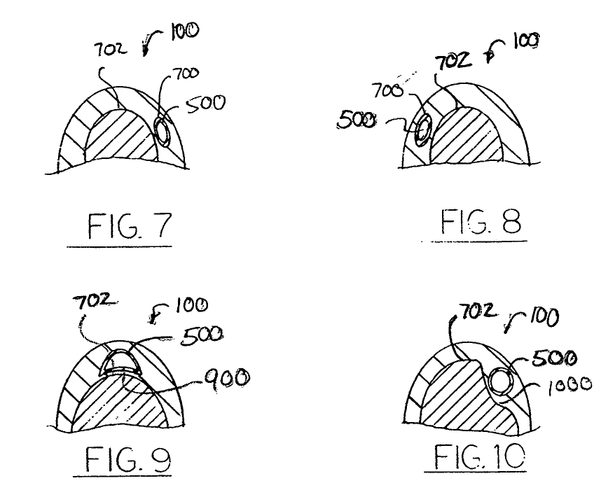

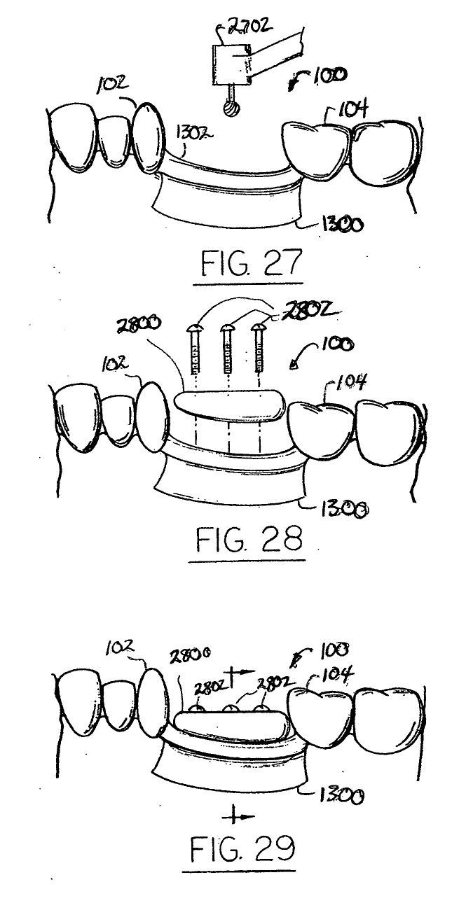

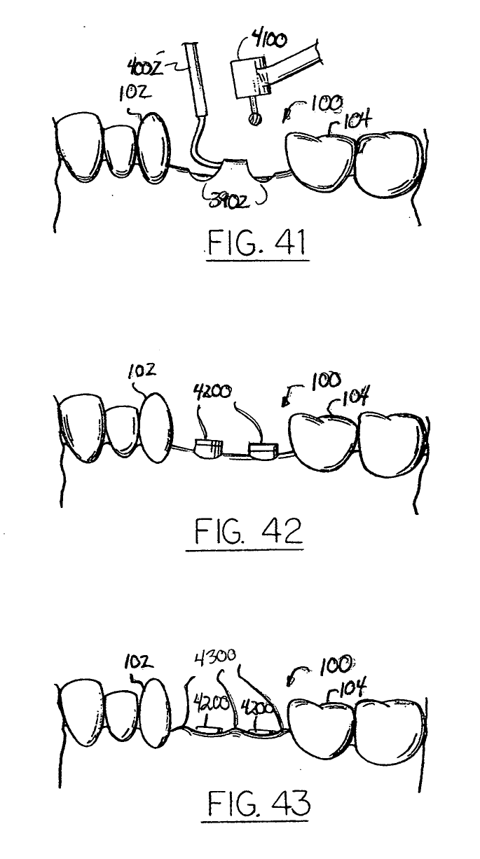

Referring now to the drawings, wherein like reference numerals refer to like parts throughout the several views, there is shown in FIGS. 1-26 a method of using a tissue contourer in oral surgery that includes placing a tissue contourer into an incision adjacent to an edentulous ridge, expanding the tissue contourer to expand the mucosal tissue adjacent to the edentulous ridge, and removing the tissue contourer. FIGS. 27-43 illustrate methods of fixing implants and bone grafts to the bone in the edentulous gap where the tissue contourer previously expanded the tissue.

In FIG. 1, a side view of an edentulous gap 100 between two adjacent teeth 102, 104 that define the ends of the gap. The gap 100 may be in any quadrant of the mouth: anterior, left posterior or right posterior. It may be either in the mandible or in the maxilla.

The gap 100 may be comprised of any number of missing teeth, including one tooth, all the teeth on a ridge (i.e. a completely edentulous ridge), or any number of teeth between one and all the teeth.

The gap may be entirely on one quadrant, it may extend across two adjacent quadrants, or it may extend across three adjacent quadrants.

A dashed line is shown in FIG. 1, which represents an incision 106. Incision 106 is made along the crest of the edentulous ridge 108. The incision 106 does not terminate at the ends of the edentulous gap, but continues beyond the gap adjacent to the existing end gap teeth 102, 104 which are disposed at opposing ends of the edentulous gap 100.

The facial tail portions 112, 114, of incision 106 extend beyond the ends of the edentulous gap. They are provided to reduce the strain on the lingual edge 116 and facial edge 118 of the incision 106 when edges 116 and 118 are later sutured.

FIG. 2 is a top view of the edentulous gap after incision 106 has been made. Note that there are lingual tail portions 200, 202 of the incision as well.

FIG. 3 illustrates the next step in the process: reflecting the incised mucosal tissue back to provide an opening to receive a tissue contourer or expander. In FIG. 3, the edges of the incision have been separated and drawn apart to form two flaps, a lingual flap 300 and a facial flap 302. These flaps are reflected, or drawn apart, to expose the top of the edentulous ridge. Depending upon the process used to form the incision, and the care taken to reflect the tissue, there may be a layer of periosteal tissue overlying the ridge. This layer is preferably manually removed to provide access to the underlying bone.

The periosteal tissue is preferably removed with a scraper or a powered burr, such as burr 304. In one process the periosteal tissue alone is removed. In an alternative process, the periosteal tissue and the outer layers of bone are removed. Removing the periosteal tissue permits the contourer to be cemented or otherwise mechanically bonded to the edentulous ridge.

As shown in FIG. 4, the lingual flap 300 is reflected toward the tongue and the facial flap 302 is reflected toward the face. In the preferred embodiment, this reflection uncovers the entire ridge crest in the edentulous gap 100.

FIG. 5 illustrates the step of inserting and securing the tissue expander or tissue contourer along the ridge in the edentulous gap 100. This tissue expander or tissue contourer 500 preferably abuts teeth 102, 104. These teeth define the ends of the gap 100. The tissue contourer or expander is preferably any of the tissue contourers or expanders described in U.S. Provisional Patent Application No. 60/455,629 or the co-pending patent application entitled “Oral Tissue Contourer”, filed contemporaneously herewith, which are incorporated herein by reference for all that they teach.

The tissue contourer is oriented such that its longitudinal axis extends parallel to the ridge of edentulous gap 100 (the edentulous ridge) and it is lowered into contact with the crest of the ridge. Once in this position, the flaps that were previously reflected in FIG. 4 are drawn over the top of the tissue contourer 500 and are sutured together over the top of contourer 500 to enclose it. If the contourer 500 has an elongated port 502 that extends from the main body 501 of the contourer, the port 502 can be disposed to extend from underneath the sutured flaps, as shown in FIG. 5. In other arrangements, to be discussed below, the port may extend from either end or from the middle of the body 501 of contourer 500. Surgical cement or mechanical fasteners are used to attach the contourer 500 to the edentulous ridge to further prevent the contourer from moving relative to the maxilla or mandible.

Once in position with the flaps sutured across the top of the contourer, the sutured incision 106 is permitted to heal. The contourer is introduced into the incision when it is unexpanded, thereby permitting the incision to be sutured with little or no residual stress on the sutures in a tension-free primary closure. The incision heals relatively rapidly and without complications when the sutures are not stressed.

While the contourer 500 is preferably disposed along the crest of the edentulous ridge, it may be shifted to one side or another along the ridge crest to expand tissue in a preferred direction.

FIG. 6 shows the contourer 500 positioned along the crest of the edentulous ridge and extending the length of the edentulous gap that terminates with teeth 102 and 104. In FIG. 6, incision 106 has healed and the sutures have been removed. A needle, syringe or other device 602 is inserted into port 502 to fill, expand and contour the contourer by filling it with fluid.

While this is a preferred method for enlarging or expanding the contourer, any of the contourers pictured herein may be constructed in various manners to increase in volume by a variety of physical principles. It should be understood that the appearance of a port 502 in the accompanying FIGURES is not intended to limit the illustrated contourer 500 to one that is expanded by filling with fluid. Contourer 500 is shown in a position shifted more toward the facial side of the crest. This positioning causes the tissue to be contoured more toward the facial side of the eroded ridge, which in turn accommodates bone grafts that are also disposed more toward the facial side of the ridge.

FIGS. 7-10 are alternative cross-sections of the edentulous ridge and the contourer 500 showing several alternative positions of the tissue contourer that are preferred alternative positions. Tooth 104 has been removed in each of these FIGURES for ease of illustration.

FIG. 7 shows the tissue contourer 500 disposed along the crest of the edentulous ridge and toward the facial side of the ridge. In this position the top 700 of the contourer 500 is adjacent to the crest 702 of the edentulous ridge.

FIG. 8 shows contourer 500 disposed along the crest of the edentulous ridge and toward the lingual side of the ridge. The top 700 of contourer 500 is adjacent to the crest 702 of the edentulous ridge.

FIG. 9 shows the tissue contourer positioned on the crest 702 of the edentulous ridge with the bottom 900 of the contourer 500 adjacent to and abutting the crest 702 of the edentulous ridge.

FIG. 10 shows the tissue contourer 500 disposed along the crest of the edentulous ridge and toward the facial side of the ridge and in a concave portion 1000 of the bone where facial bone is missing.

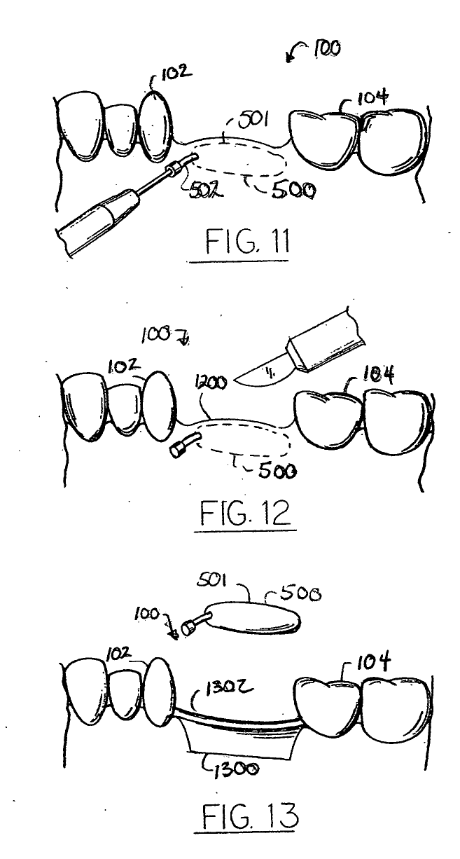

The next stage in the process is shown in FIG. 11. Tissue contourer 500 is expanded over a period of time once the incision has healed. The method by which it is expanded depends upon the construction of the tissue contourer 500 itself. For example, if the tissue contourer 500 is a bladder, it can be filled manually by inserting a needle or other tool for inflation into the wall of the contourer body 501 or into the elongate port 502 extending from the contourer body 501 as shown in FIG. 11. Tissue contourers using osmotic pressure as the mechanism for inflation, such as described in U.S. Pat. No. 4,157,085, will self-inflate. Tissue contourers configured as mechanical stents can be periodically adjusted to increase their outside diameter. Tissue contourers may also employ tissue growth enhancers to grow and contour tissue. Alternative tissue expanders may use magnetic repulsion. They may incorporate bulk expansion materials such as cellulose, for example, to increase in size and contour tissue. They may incorporate screw tensioners to apply tension to tissue to be contoured or expanded. They may also incorporate other mechanical expansion devices.

Regardless of the method of expansion, the diameter of the contourer 500 is increased over a period of time, increasing the void in which the contourer is inserted. This gradual enlargement of the contourer 500 causes the outer surface of the mucosal tissue overlying the contourer 500 to gradually conform itself to the surface contours of the contourer, forming papillae where the contourer 500 has outwardly facing projections. Examples of these projections can be seen in the co-pending “Oral Tissue Contourer” application.

Once the contourer 500 has expanded and contoured the desired amount it is removed, as shown in FIG. 12. FIG. 12 shows the contourer 500 as it would appear just before removal, with the overlying tissue contoured to match the surface of the contourer. In the preferred embodiment, the operator makes an incision 1200 in the mucosal tissue that generally follows the crest of the edentulous ridge. Once incision 1200 has been made, the two flaps 1300, 1302 (FIG. 13) thereby created are reflected back from the incision 1200 and the contourer 500 is removed.

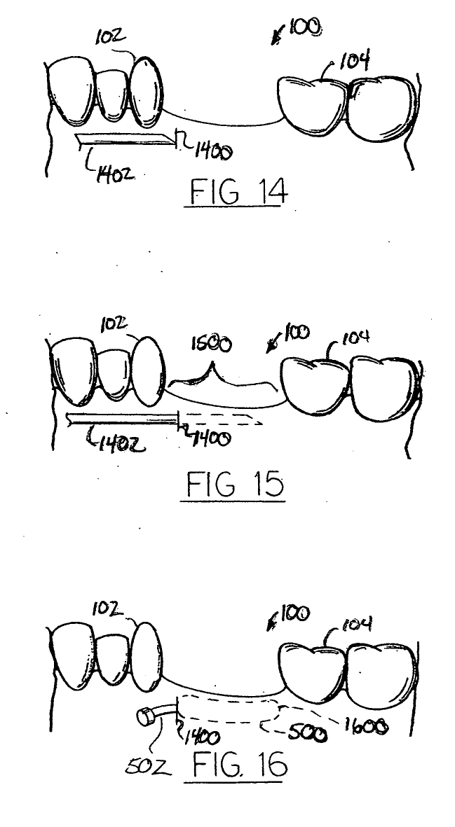

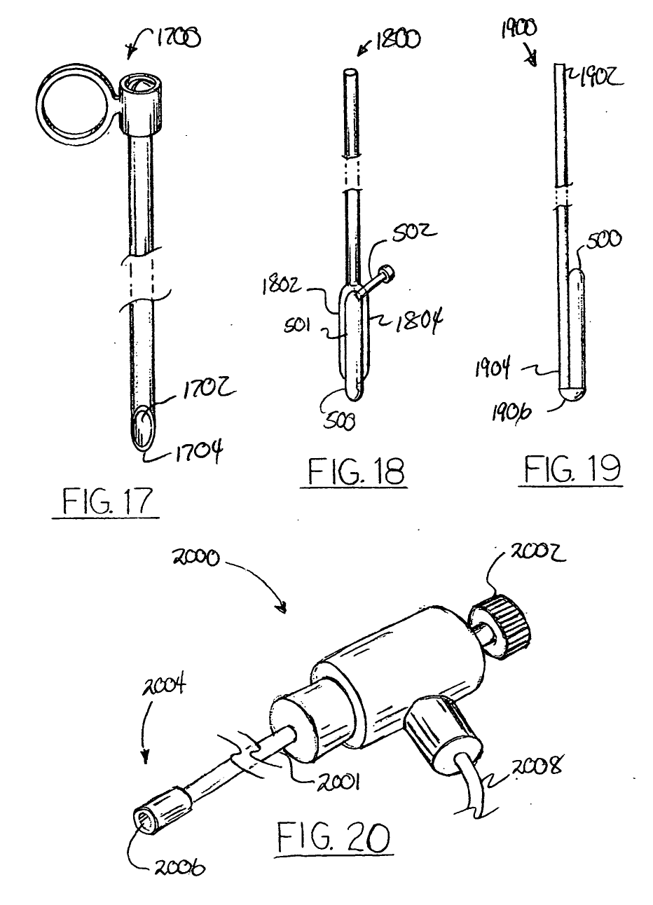

In the process above, a first incision was made into which the tissue contourer was inserted. This incision was then sutured and a time interval was provided for the incision to heal before the contourer 500 was expanded. As with any treatment is always desirable to reduce the amount of surgical trauma and enhance healing. This is best provided in the present application by avoiding the creating of the initial incision by creating a void beneath the mucosal tissue and inserting the contourer 500 into this void. This process is illustrated in FIGS. 14-16, and the surgical tools that may be used for this purpose are shown in FIGS. 17-20.

Referring to FIGS. 14 and 15, a short initial incision 1400 is made generally perpendicular to the length of the edentulous ridge. An elongated probe 1402, such as one of those shown in FIGS. 17-20 is inserted into this incision. The probe is forced through the incision and along the crest of the edentulous ridge creating a pocket or void that extends the entire length of the edentulous gap, from tooth 102 at one end of the gap to tooth 104 at the other end of the gap. The void 1500 (FIG. 15) thereby created preferably terminates adjacent to both of the teeth 102 and 104.

Once void 1500 has been created, the probe is removed and the same (or another) probe is inserted in to the void. That probe or another probe may be inserted into the void a second time coupled to a contourer 500, and dragging the contourer 500 into the void by pushing the leading end 1600 of contourer 500 into a position adjacent tooth 104 at the closed end of the void. Examples of probes and expanders or contourers to which they are coupled may be found in the co-pending “Oral Tissue Contourer” application as well as in FIGS. 17-20 herein. If contourer 500 has an elongated port extending from the body of the contourer, a portion of this port can be left outside the incision to permit the contourer to be filled. In the event the contourer does not have such a port, the entire contourer is preferably inserted into the void.

In the process and arrangement of FIGS. 14-16, the contourer can be immediately enlarged. Since there is no elongated incision such as incision 106 with sutures that can be torn loose, there is no need to wait for the incision to heal. The small incision 1400 through which the tissue contourer was inserted is preferably oriented perpendicular to the extent of the contourer and is preferably located at one end of the contourer. It therefore does not tend to tear open when the contourer is expanded.

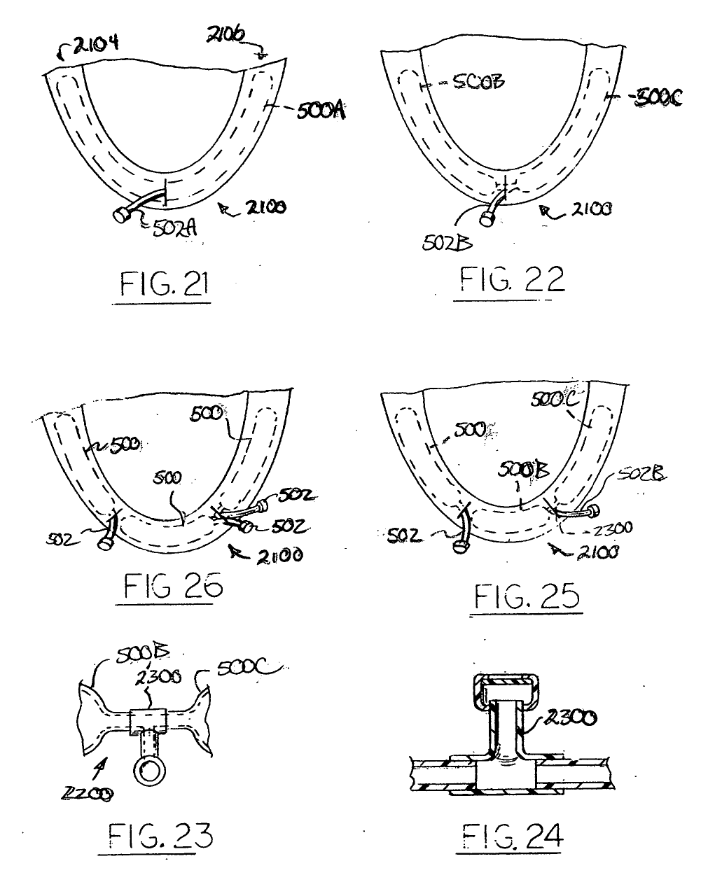

FIGS. 17-20 disclose several devices for making void 1500 and inserting contourer 500 into the void. In FIG. 17 a cannula 1700 is shown that has an elongated internal passage 1702 into which contourer 500 or an endoscope 2000 (FIG. 20) may be inserted. In a first process, the operator may insert the tip 1704 of cannula 1700 through incision 1400 and insert endoscope 2000 into the cannula. The operator views the mucosal tissue through endoscope 2000 and guides the cannula (and the endoscope it surrounds), cutting a surgical path through the tissue that defines void 1500. In this manner, the operator creates a path that closely follows the contours of the edentulous ridge,

Once the void is formed, the operator inserts tissue contourer 500 into cannula 1700 and places it in the void, withdrawing the cannula from the void while ejecting the contourer from the end. Alternatively, the operator withdraws the cannula and inserts contourer 500 into the void.

FIG. 18 shows a forked insertion probe 1800 having two prongs 1802, 1804 that extend from one end of probe 1800. The operator places contourer 500 between these prongs to load the probe 1800 and inserts the loaded probe 1800 into void 1500 through incision 1400. The operator manipulates the probe until the contourer 500 is in the proper position in the void, at which point the operator withdraws the probe 1800 leaving contourer 500 in place.

FIG. 19 shows a straight insertion probe 1900 engaged to an alternative contourer 500. Probe 1900 is an elongate member having a distal end 1902 and a proximal end 1904. Proximal end 1904 is configured to mate with and engage tip 1906 of contourer 500. The operator inserts proximal eng 1904 into tip 1906, thereby engaging the two. The operator grasps distal end 1902 and inserts proximal end 1904 together with tip 1906 into incision 1400. By forcing probe 1900 forward into incision 1400, the operator drags contourer 500 forward and into void 1500 by its tip 1906, dragging the rest of contourer 500 behind the tip until the contourer is in the proper position in void 1500.

FIG. 20 illustrates an endoscope 2000 for inspecting the void and for guiding the contourer into position. The endoscope includes an elongated barrel 2001, having a knob 2002 at one end, the other end 2004 having a light-receiving opening 2006 configured to receive light. A light-carrying conduit 2008 extends laterally from the barrel to a remote image monitoring device (not shown) such as an electronic display, that receives and displays an image generated by the light gathered by the light-receiving opening 2006.

In the foregoing embodiments, the contourer 500 is shown as a single elongated body filling the entire edentulous gap. Furthermore, the contourer body is shown as abutting the teeth adjacent the ends of the edentulous gap. Even further, the elongated port for filling the contourer is shown extending from one end of the contourer body. While these are the preferred forms and orientations of contourer 500, there are other forms and orientations that are suitable, such as those shown in FIGS. 21-26.

In FIGS. 21-26 a totally edentulous ridge 2100 is shown. This ridge may be a maxillary or a mandibular ridge. It has no teeth that terminate the edentulous gap. In FIG. 21, the first of these FIGURES, a single contourer 500A is shown. This contourer has a central port 502A and two ends 2104 and 2106, each end disposed adjacent to the retromolar pads (if the contourer is in the mandible) or the tuberosity (if the contourer is disposed in the maxilla). The contourer may be placed in an incision (not shown in FIGS. 21-26) using the process shown in FIGS. 1-11 or it may be inserted by a probe into a space using the process shown in FIGS. 14-16.

FIG. 22 illustrates an alternative contourer arrangement similar to that of FIG. 21, but in the form of two contourers that are disposed adjacent to each other in an abutting relationship. These two contourers 500B, 500C are coupled to and are filled by a common port 502B.

FIG. 23 illustrates the Y-tube 2300 of common port 502B that joins the two contourers. FIG. 24 is a cross-sectional view of the Y-tube showing the check valve structure in the Y-tube 2300 that prevents fluid from escaping the contourers 500B, 500C.

In FIG. 25, an arrangement of three contourers 500, 500B, 500C that are disposed end-to-end is shown. In this embodiment, two contourers 500B and 500C are coupled together to a common port 502B by Y-tube 2300 for inflation and a third contourer 500 is placed adjacent to the end of contourer 500B with its own port 502 for inflation.

In FIG. 26, three tissue contourers 500 are disposed end-to-end are shown. Each contourer has its own port 502 which is provide for enlarging and expanding the contourer.

Thus, one, two or three tissue contourers may be disposed end-to-end in an edentulous gap, in which none, two or all are interconnected.

The foregoing FIGURES show the procedures involved in expanding and contouring mucosal tissue. Once the tissue is actually expanded and contoured, the process of inserting the implants or grafts is performed. These processes are illustrated in FIGS. 27-43. The processes of FIGS. 27-31 illustrates how a block bone graft 2800 is fixed to the edentulous ridge.

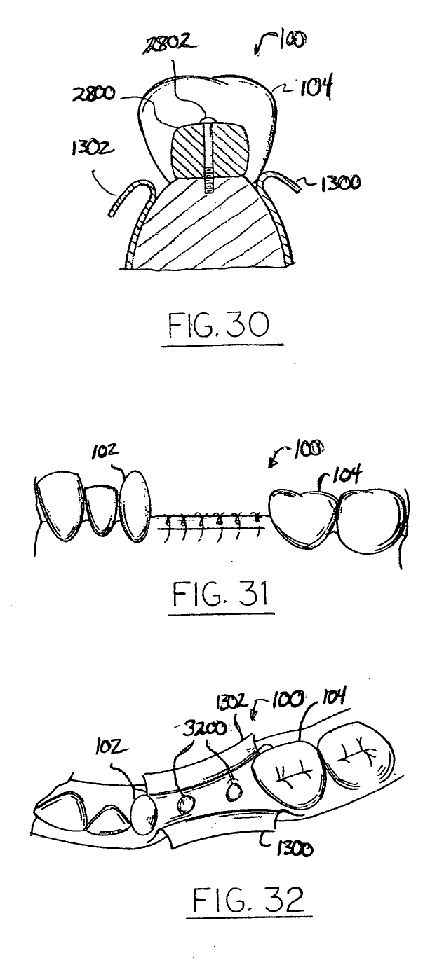

In FIG. 27, the tissue flaps 1300, 1302 formed when the tissue contourer is removed are reflected exposing the crest of the edentulous ridge. The periosteal tissue bonded to the crest of the ridge is then removed, preferably manually by a scraper or a burr 2702. This process of removal may remove just the tissue, or more preferably the top layer of bone on the edentulous ridge; it may also contour the bone of the ridge to fit the bone graft. With the top layer of tissue and bone removed, a block graft 2800 is positioned on top of the edentulous ridge and is fixed in position with several fasteners, such as screws 2802. As best shown in cross-section in FIG. 30, the fasteners extend through the block graft and into the crest of the edentulous ridge. Once the block graft is fixed to the ridge, the two tissue flaps 1300, 1302 formed when tissue contourer 500 is removed are then drawn across the block graft 2800 and sutured, covering the graft.

In a second process, which may be performed subsequent to the graft of FIGS. 27-31 or as an alternative to that process, one or more implants 3300 may be fixed to the ridge (either to the edentulous ridge itself, or the new ridge formed by the block graft of FIGS. 27-31) once the tissue contourer 500 is removed, as shown in FIG. 32-35.

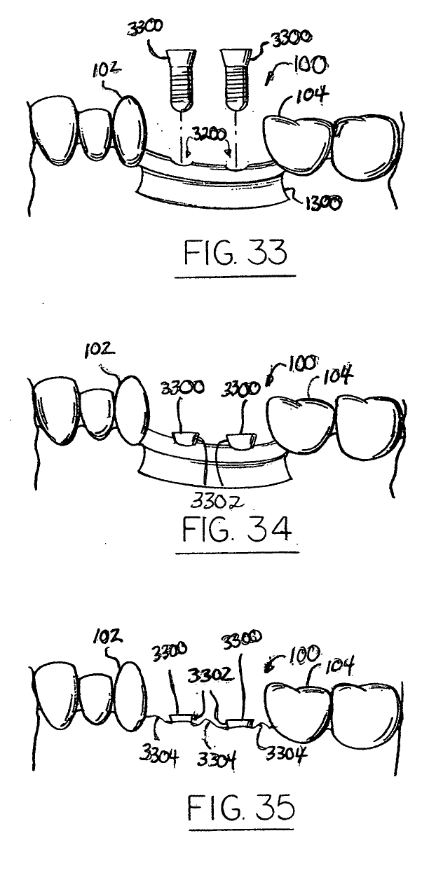

In FIGS. 32-35, the tissue flaps are reflected from the edentulous ridge (FIG. 33) and holes 3200 are formed in the edentulous ridge (FIG. 32). Implants 3300 are inserted into these holes and the flaps of tissue are drawn across the edentulous ridge and sutured together (FIG. 35), leaving the upper portions 3302 of the implants exposed as shown in the facial view of FIG. 35. The extra tissue formed by the contouring process can be gathered to form papillae such as the papillae 3304 shown in FIG. 35.

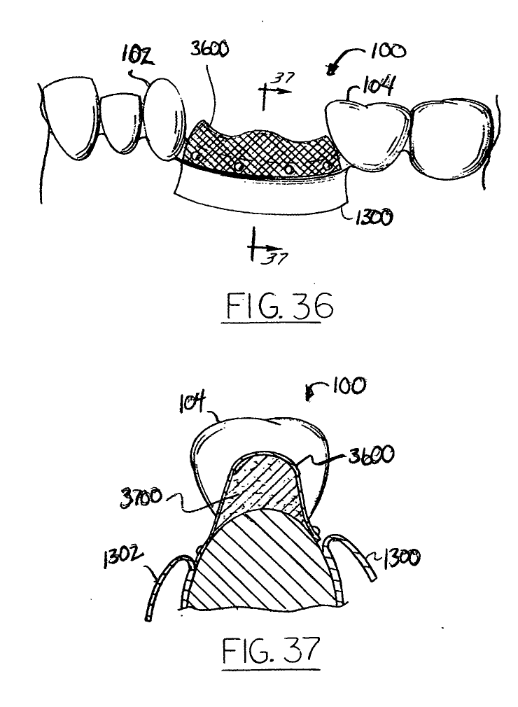

In a third process shown in FIGS. 36 and 37, a framework, mesh, or scaffold 3600 such as any of the frames or scaffolds shown in U.S. Pat. No. 6,645,250, for example, may be fixed to the edentulous ridge when the tissue flaps 1300, 1302 are reflected. The void between the framework or scaffold 3600 and the edentulous ridge is filled with bulk grafting material 3700. When this bulk graft material integrates with the bone of the edentulous ridge, an implant such as those shown in FIGS. 33-34 can be inserted.

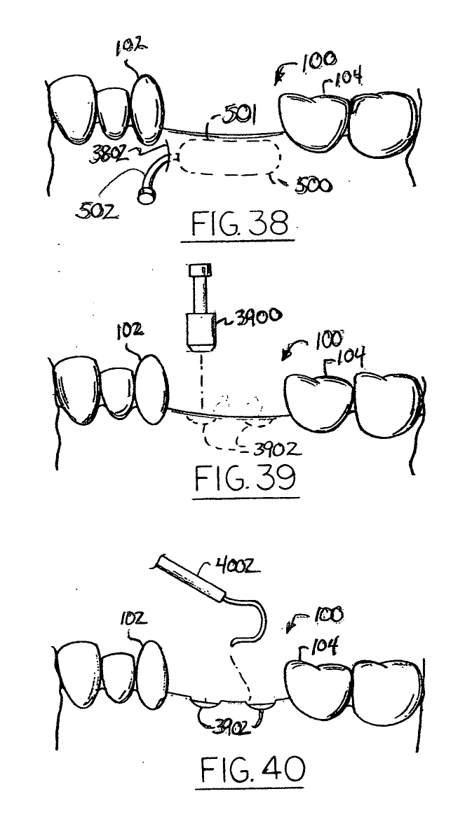

In a fourth process shown in FIGS. 38-43 a tissue punch 3900 is used to make openings in the tissue contoured by the tissue contourer 500. In this process, however, the tissue contourer 500 is preferably not removed by making an elongated incision along the top of the edentulous ridge, but by extracting the tissue contourer from a narrow incision 3802 such as the incision through which the tissue contourer 500 was originally inserted into the void (see FIGS. 15-16). Alternatively, an elongate incision such as that shown in FIGS. 12-13 can be made to remove the tissue expander, the incision sutured and permitted to heal before continuing with forming openings 3902.

Once tissue contourer 500 is removed, an operator uses tissue punch 3900 to make one or more openings 3902 in the contoured tissue along the edentulous ridge. The tissue that is punched is removed, leaving generally circular or oval openings 3902 that are configured and located to receive implants (see FIGS. 42-43). The operator then inserts an explorer or periodontal probe 4002 through openings 3902 to lift the tissue away from the edentulous ridge. With the tissue lifted away from the ridge, a burr or other abrading device 4100 is inserted through the opening to remove periosteal tissue attached to the surface of the bone underneath the expanded tissue. The abrading device 4100 removes the outer layer of periodontal tissue and the top layer of bone underneath the expanded tissue.

The operator then drills holes into the edentulous ridge where the openings 3902 are located, and anchors implants 4200 in those holes. The operator then inserts bulk bone graft material (not shown) underneath the tissue adjacent to implants 4200 with bulk bone graft material, thereby increasing the height of the mucosal tissue surrounding the implants 4200 and creating papillae 4300 between adjacent implants 4200.

From the foregoing, it will be observed that numerous modifications and variations can be effected without departing from the true spirit and scope of the novel concept of the present invention. For example, the tissue contourer may be made in many different forms other than those illustrated herein. It may be an inflatable bladder. It maybe configured as a stent or otherwise expand by the release of stored mechanical pressure generated by flexible metal or plastic members. It may be self-expanding. It may expand by automatic inflation. It may fill under osmotic pressure.

The disclosure is intended to cover by the appended claims all such modifications as fall within the scope of the claims below.

What is claimed is:

1. A method for implanting oral devices including the steps of:
making a first incision in the oral cavity:
inserting a tissue contourer into the first incision overlying a first edentulous ridge portion of the maxilla or mandible;
expanding the tissue contourer;
removing the tissue contourer; and
fixing an oral implant to the first edentulous ridge portion.

2. The method of claim 1, including the step of making a second incision in the oral cavity prior to the step of removing the tissue contourer.

3. The method of claim 2, including the step of making the second incision in mucosal tissue overlying the tissue contourer.

4. The method of claim 1, further including the step of waiting for the first incision to heal before the step of expanding the tissue contourer.

5. The method of claim 1, wherein the step of fixing an oral implant may include the step of fixing a dental endosseous implant, framework, scaffold, prosthetic, or grafting material to the first edentulous ridge portion.

6. The method of claim 1, wherein the first incision is made at one end of the first edentulous ridge portion.

7. The method of claim 6, further comprising the step of inserting a probe into the first incision.

8. A method of preparing mucosal tissue for an oral implant including the steps of:
making a first elongated incision in mucosal tissue in an edentulous gap that extends the length of the gap:
inserting a tissue contourer into the first elongated incision overlying a first edentulous ridge portion of the maxilla or mandible; and
expanding the tissue contourer.

9. The method of claim 8, further comprising the step of suturing the first elongated incision over the top of the tissue contourer.

10. The method of claim 8, further comprising the step of expanding the tissue contourer by a process selected from the group consisting of manually inserting fluid into the body, osmosis, releasing energy stored in the contourer, and bulk expansion.

11. The method of claim 8, further comprising the step of making the first elongated incision adjacent to and parallel to the top of the edentulous gap.

12. The method of claim 8, further comprising the step of permitting the first elongate incision to heal before the step of expanding the tissue contourer.

13. The method of claim 8, wherein the tissue contourer has a longitudinal axis and further wherein the step of inserting the tissue contourer includes the step of orienting the longitudinal axis of the tissue contourer parallel to the edentulous ridge.

14. The method of claim 8, further comprising the step of suturing mucosal tissue over the tissue contourer placed in the first elongate incision.

15. The method of claim 8, further comprising the steps of:
removing the tissue contourer; and
fixing an oral implant to the first edentulous ridge portion.

16. The method of claim 15, wherein the step of fixing an oral implant may include the step of fixing a dental endosseous implant, framework, scaffold, prosthetic, or grafting material to the first edentulous ridge portion.

17. A method for implanting oral devices including the steps of:
inserting a tissue contourer in a void beneath oral mucosal tissue;
expanding the tissue contourer;
removing the tissue contourer; and
fixing an oral implant to the first edentulous ridge portion.

18. The method of claim 17, wherein the step of fixing an oral implant may include the step of fixing a dental endosseous implant, framework, scaffold, prosthetic, or grafting material to the first edentulous ridge portion.

19. The method of claim 18, further comprising the step of expanding the tissue contourer by a process selected from the group consisting of manually inserting fluid into the body, osmosis, releasing energy stored in the contourer, and bulk expansion.

20. The method of claim 17, further comprising the step of abrasively removing periosteal tissue from the void.

21. The method of claim 8, further comprising a step of removing the tissue contourer and the step of abrasively removing periosteal tissue after the step of removing the tissue contourer, wherein the tissue removed is that tissue disposed between the tissue contourer and the first edentulous ridge during the step of expanding the tissue contourer.

22. The method of claim 17, further comprising the step of suturing mucosal tissue over the top of the tissue contourer.

23. The method of claim 22, wherein the step of expanding the tissue contourer includes the step of inflating the tissue expander.

24. The method of claim 22, wherein the step of expanding the tissue contourer includes the step of filling the tissue expander with fluid.

25. The method of claim 22, wherein the step of expanding the tissue contourer includes the step of expanding the tissue contourer by osmotic pressure.

26. The method of claim 17, further including the step of:
inserting an endoscope into a contourer-receiving void and examining the void.
